(19) United States
(12) Patent Application Publication
(10) Pub. No.: US 2026/0234485 A1
(43) Pub. Date: Aug. 13, 2026

(54) METHOD FOR PRODUCING BIOFUEL, APPARATUS FOR PRODUCING BIOFUEL, AND BIO-OIL

(71) Applicant: KOREA INSTITUTE OF ENERGY RESEARCH, Daejeon (KR)

(72) Inventors: Young Chan CHOI, Daejeon (KR); Young Joo LEE, Sejong (KR); Gyu Seob SONG, Daejeon (KR); Jong Won CHOI, Daejeon (KR); Hak Geun JOENG, Daejeon (KR); Ju Hyoung PARK, Daejeon (KR); Young Hoon NOH, Daejeon (KR); Jin Seung KIM, Daejeon (KR)

(73) Assignee: KOREA INSTITUTE OF ENERGY RESEARCH, Daejeon (KR)

(21) Appl. No.: 19/148,216

(22) PCT Filed: Feb. 29, 2024
(86) PCT No.: PCT/KR2024/002655

§ 371 Date: Jul. 15, 2025

(30) Foreign Application Priority Data
Nov. 16, 2023 (KR) 10-2023-0159186
Dec. 6, 2023 (KR) 10-2023-0175560

(51) Int. Cl. C10L 9/08; C10B 47/30; C10B 53/02; C10L 1/02; C10L 1/19; C10L 5/06; C10L 5/44

(52) U.S. Cl. CPC C10L 9/08; C10B 47/30; C10B 53/02; C10L 1/02; C10L 1/19; C10L 5/06; C10L 5/445; C10L 5/447; C10L 2200/0484; C10L 2290/02; C10L 2290/32

(57) ABSTRACT

Provided is a method for preparing biofuel that is economical and has effects on both carbon reduction and resource recycling. According to one aspect, provided is the method for preparing biofuel, the method including (S1) preparing raw materials containing one or more selected from the group consisting of a cashew nut shell, a cashew nut shell cake, a vegetable oil residue, and a husk; and (S2) obtaining sub-gas, biochar, and bio-oil by pyrolyzing the raw materials using a pyrolysis method.

### TECHNICAL FIELD

The present disclosure relates to a method for preparing biofuel, more specifically a method of preparing biofuel, a biofuel production apparatus, and bio-oil.

### BACKGROUND ART

Recently, as the excellency of biomass fuel as a renewable energy source has been newly recognized, research on biomass energy conversion techniques has been actively conducted in countries around the world. Accordingly, development of biomass energy conversion techniques has been currently occurring at a rapid pace. Among these biomass energy conversion techniques, the most notable technique is bio-oil production technique. Bio-oil is oil produced from woody and herbaceous biomass. Bio-oil can be a raw material for chemical products, like crude oil which is a raw material for petroleum fuel or petrochemical products. Bio-oil also has higher energy density than solid raw materials, so bio-oil has the advantage that its transportation and storage costs are low. In addition, bio-oil is easy to handle because bio-oil is in liquid state, so bio-oil has the advantage of being highly useful as a fuel for heating and power generation.

Meanwhile, a cashew nut is being considered as a raw material for biofuel production. A cashew nut is a type of nut that is popular in both East and West and used in various dishes or as a snack or accompaniment to alcohol. A cashew nut grows attached to the bottom of a cashew apple on a cashew tree, enclosed in a shell.

After producing a cashew nut from a cashew tree, a shell of the cashew nut is left as a by-product. The cashew nut shell contains about 30% to 35% of cashew nut shell liquid, an oil component.

Methods for extracting cashew nut shell liquid from a cashew nut shell include mechanical extraction (pressing), heat treatment (roasting), distillation, supercritical fluid, and solvent extraction. Depending on the extraction methods, the composition of major components in the cashew nut shell liquid, and production yield vary. The cashew oil extraction method currently commercialized in Vietnam and other countries is the mechanical extraction (pressing). 60% to 70% of the produced cashew nut shell liquid consists of anacardic acids, which are phenolic lipids. Anacardic acids are organic compounds in which an alkyl group and a carboxyl group are chemically bonded to a phenol group. Anacardic acids have the characteristic of causing dermatitis and rashes when it comes into contact with the skin. Due to that, local cashew nut production workers are experiencing a lot of inconveniences. This mechanical extraction (pressing) takes a short time and can easily extract cashew nut shell liquid. However, a cashew nut shell still contains excess cashew nut shell liquid and a large amount of impurities such as ash. Accordingly, when cashew nut shell liquid, which contains a large amount of ash, is used as fuel, various problems can occur, such as corrosion, fouling, and slagging of engines or power plant equipment. In addition, the use of cashew nut shell liquid as fuel can reduce reactivity of high-value-added products such as hardeners, surfactants, and resins.

In addition, anacardic acids, the main component in pressed-extracted cashew nut shell liquid, are a cause of increased total acid value and viscosity. Measurement for the total acid value means measuring a free fatty acid content in cashew nut shell liquid. The higher the content of the anacardic acids, which have a free fatty acid form of cardanol, the higher the total acid value is measured. Viscosity is somewhat related to a freezing point of a liquid. A melting point of anacardic acids is 34° C. and a melting point of cardanols is −20° C., so the viscosity of anacardic acids is high at room temperature. Due to the fact that anacardic acids causes dermatitis and rashes when they come into contact with the skin, a separate process to convert to cardanols was required, and at the same time, there was another problem of removing impurities. Therefore, to utilize cashew nut shell liquid produced by the method of the mechanical extraction as fuel or a high value-added material, it is required to convert anacardic acids, which are the main component, to cardanols, and at the same time, to remove impurities.

### DISCLOSURE

### Technical Problem

One objective of the present disclosure is to provide a method for preparing biofuel that is economical and has effects on both carbon reduction and resource recycling.

Another objective of the present disclosure is to provide a method for preparing biofuel with higher heating value through a simple process.

A further objective of the present disclosure is to provide a method for preparing biofuel that can improve process efficiency and reduce preparation costs by reusing gas generated during the biofuel preparation method as a heat source for pyrolyzing raw materials.

A yet further objective of the present disclosure is to provide a biofuel production apparatus that can implement the biofuel preparation method.

The objectives of the present disclosure are not limited to the objects mentioned above. Other objectives and advantages of the present disclosure that are not mentioned can be understood by the following description and will be more clearly understood by the embodiments of the present disclosure. In addition, it will be readily apparent that the objectives and advantages of the present disclosure can be realized by means and combinations thereof as set forth in the claims.

### Technical Solution

According to a first aspect of the present disclosure to achieve the objectives, provided is a method for preparing biofuel, the method including (S1) preparing raw materials containing one or more selected from the group consisting of a cashew nut shell, a cashew nut shell cake, a vegetable oil residue, and a husk; and (S2) obtaining sub-gas, biochar, and bio-oil by pyrolyzing the raw materials using a pyrolysis method.

According to a second aspect of the present disclosure, in the first aspect, vegetable oil of the vegetable oil residue may include one or more selected from the group consisting of palm oil, soybean oil, coconut oil, rapeseed oil, olive oil, corn oil, and peanut oil.

According to a third aspect of the present disclosure, in the first or second aspect, the husk may include one or more selected from the group consisting of a coffee husk, a palm oil husk (Palm kernel shell, PKS), and a grain husk.

According to a fourth aspect of the present disclosure, in any one of the first to third aspects, the pyrolysis method may include one or more methods selected from the group consisting of rotary kiln pyrolysis, fluidized bed pyrolysis, batch pyrolysis, and screw pyrolysis.

According to a fifth aspect of the present disclosure, in any one of the first to fourth aspects, the sub-gas may be reused as a heat source for the pyrolysis method. Specifically, the sub-gas is transferred to a combustion device through a heat exchanger, heated in the combustion device, and then transferred to a pyrolysis reactor to be reused as a heat source for pyrolyzing raw materials.

According to a sixth aspect of the present disclosure, in any one of the first to fifth aspects, the bio-oil may include phenol derivatives.

According to a seventh aspect of the present disclosure, in the sixth aspect, the phenol derivatives may include one or more selected from the group consisting of compounds represented by Formulas 1 to 3 below.

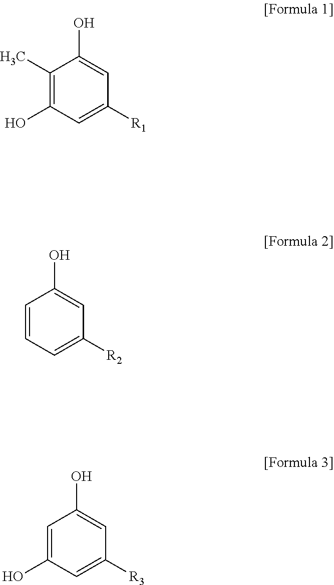

In Formulas 1 to 3, R₁ to R₃ are each independently a carbon chain functional group having a carbon number of 15 and containing one or more selected from the group consisting of an unsaturated bond and a saturated bond.

According to the eighth aspect of the present disclosure, in any one of the first to seventh aspects, provided may be a method for preparing biofuel, the method further including one or more selected from the consisting of (S3a) preparing a first biofuel by molding the biochar into pellets; and (S3b) preparing a second biofuel by trans-esterifying the bio-oil.

According to the ninth aspect of the present disclosure, provided is a biofuel production apparatus, the apparatus including a raw material injection unit where raw materials are injected; a pyrolysis reactor connected to the raw material injection unit; a cooler connected to the pyrolysis reactor; a heat exchanger connected to the pyrolysis reactor; a first recovery unit connected to the cooler and recovering biochar; and a second recovery unit connected to the heat exchanger and recovering bio-oil. Herein, the raw materials include one or more selected from the group consisting of a cashew nut shell, a cashew nut shell cake, a vegetable oil residue, and a husk.

According to a tenth aspect of the present disclosure, in any one of the first to ninth aspects, the pyrolysis reactor may include one or more selected from the group consisting of a rotary kiln reactor, a fluidized bed reactor, a batch pyrolysis reactor, and a screw pyrolysis reactor.

According to the eleventh aspect of the present disclosure, in the ninth or tenth aspect, the biofuel production apparatus may further include a combustion device connected to the heat exchanger and the pyrolysis reactor.

According to the twelfth aspect of the present disclosure, provided is bio-oil, which is derived from cashew nut shell liquid (CNSL) containing anacardic acids, in which the bio-oil contains phenol derivatives derived from the anacardic acids. Herein, the bio-oil according to the twelfth aspect may be prepared by one or more biofuel preparation methods of the first to eighth aspects. In addition, the bio-oil according to the twelfth aspect may be prepared by one or more biofuel production apparatuses of the ninth to eleventh aspects.

According to the thirteenth aspect of the present disclosure, in the twelfth aspect, the anacardic acids may be contained in an amount of 60% to 70% by weight based on the total weight of the cashew nut shell liquid.

According to a fourteenth aspect of the present disclosure, in the twelfth or thirteenth aspect, the phenol derivatives may include one or more selected from the group consisting of compounds represented by Formulas 1 to 3 below.

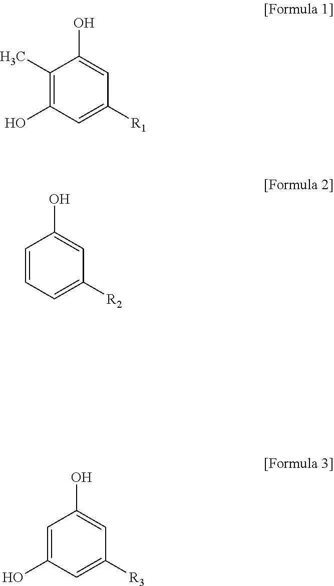

In Formulas 1 to 3, R₁ to R₃ are each independently a carbon chain functional group having a carbon number of 15 and containing one or more selected from the group consisting of an unsaturated bond and a saturated bond.

According to the fifteenth aspect of the present disclosure, in the fourteenth aspect, the bio-oil may contain 70% to 80% by weight of the compound represented by Formula 1 and 10% to 20% by weight of the compound represented by Formula 2.

According to a sixteenth aspect of the present disclosure, in the fourteenth or fifteenth aspect, the bio-oil may further contain more than 0% and less than or equal to 10% by weight of the compound represented by Formula 3.

The solutions to the problems do not enumerate all the features of the present disclosure. The various features of the present disclosure and its advantages and effects can be understood in more detail by referring to the specific embodiments below.

### Advantageous Effects

According to one aspect of the present disclosure, a method for preparing biofuel with high heating value can be implemented through a simple process.

According to another aspect of the present disclosure, a method for preparing biofuel can be implemented, which is economical and has effects on both carbon reduction and resource recycling.

According to a further aspect of the present disclosure, a method for preparing biofuel can be implemented for use of biofuel in various application fields, like biodiesel.

In addition to the effects described above, the specific effects of the present disclosure are described below while explaining the specific details for carrying out the present disclosure.

### DESCRIPTION OF DRAWINGS

FIG. 1a shows a flow chart showing a method for preparing biofuel according to one embodiment of the present disclosure;

FIG. 1b shows a biofuel production apparatus according to another embodiment of the present disclosure;

FIG. 2 shows a flow chart showing a method for preparing biofuel according to a further embodiment of the present disclosure;

FIG. 3 shows a differential scanning calorimetry (DSC) graph of cashew nut shells in the method according to Example 1;

FIG. 4 shows a DSC graph of cashew nut shell liquid in the method according to Example 1;

FIG. 5a shows a DSC graph of oil made from corn stover, FIG. 5b shows a DSC graph of oil made from wood pellets, and FIG. 5c shows a DSC graph of oil made from coffee grounds;

FIG. 6a shows a DSC graph of cashew nut shells according to Example 1 at 200° C. to 300° C., and a calculation formula to confirm exothermic properties of the cashew nut shells;

FIG. 6b shows a DSC graph of cashew nut shell liquid according to Example 1 at 200° C. to 300° C., and a calculation formula to confirm exothermic properties of the cashew nut shell liquid; and

FIG. 7 shows graphs showing specific heats depending on each temperature for the cashew nut shells (CNS), cashew nut shell liquid (CNSL), corn stover, wood pellets, and coffee husks.

### MODE FOR DISCLOSURE

In this specification, singular expressions include plural expressions, unless the context clearly indicates otherwise.

The term “connection” used in this specification not only means that certain members are directly connected, but also includes indirectly connected members with other members interposed between them.

When multiple embodiments are described in this specification, each embodiment may be combined unless specifically stated to the contrary. At this time, the effect of the present disclosure can be defined as including the effect resulting from each embodiment and the effect occurring as each embodiment is organically combined. For example, even though Embodiments 1 and 2 are described independently in this specification, Embodiments 1 and 2 may be organically combined with each other, unless the context clearly indicates otherwise. The effect of the present disclosure may include the effect that occurs by combining Embodiments 1 and 2.

The range of values expressed using the term “to” in this specification refers to the range of values that include the values described before and after the term as the lower limit and upper limit, respectively. When multiple numerical values for the upper and lower limits of an arbitrary numerical range are disclosed, the numerical range disclosed in this specification may be understood as an arbitrary numerical range in which any one value among a plurality of lower limit values and any one value among a plurality of upper limit values are set as the lower limit value and the upper limit value, respectively. For example, when described in the specification as a to b, or c to d, it may be understood that a or more than b or less, a or more or d or less, c or more or d or less, or c or more and b or less are described.

In this specification, “including at least one of a, b, and c” may mean including a, b, or c alone or including a combination of two or more selected from the group consisting of a, b, and C.

In this specification, terms such as “about” or “substantially” mean a reasonable amount of deviation from the modified term so that the final result does not change significantly. These terms may be interpreted to include a deviation of at least ±5% or at least ±10%, provided that the deviation does not alter and invalidate the meaning of the word.

### 1. Method of Preparing Biofuel

By a mechanical extraction method, which was previously mainly used to convert cashew nut shell liquid (CNSL) obtained from a cashew nut shell into biofuel, when extracting the cashew nut shell liquid from the cashew nut shell, a large amount of impurities such as ash are extracted. When cashew nut shell liquid, which contains this large amount of ash, is used as fuel, various problems can occur, such as corrosion, fouling, and slagging of engines or power plant equipment. In addition, the use of cashew nut shell liquid as fuel may also reduce reactivity of high value-added products such as hardeners, surfactants, and resins. Not only that, anacardic acids, which are a main component of cashew nut shell liquid, also causes dermatitis and rashes when they come in contact with the skin. Therefore, it is required to convert anacardic acids into cardanols, and at the same time, to remove impurities. From another perspective, when cashew nut shell liquid is prepared by mechanically pressing a cashew nut shell, additional processes, such as a heat treatment process to convert anacardic acids to cardanols and a separation process involving an esterification reaction of free fatty acids and a removal of impurities, were required to produce bio heavy oil from the cashew nut shell liquid. In other words, as additional processes were required, preparation costs increased, and excessive process equipment was required.

According to one aspect, provided is a method for preparing biofuel, the method including (S1) preparing raw materials containing one or more selected from the group consisting of a cashew nut shell, a cashew nut shell cake, a vegetable oil residue, and a husk; and (S2) obtaining sub-gas, biochar, and bio-oil by pyrolyzing the raw materials using a pyrolysis method. According to the one aspect, by including the (S1) preparing raw materials containing one or more selected from the group consisting of a cashew nut shell, a cashew nut shell cake, a vegetable oil residue, and a husk; and the (S2) obtaining sub-gas, biochar, and bio-oil by pyrolyzing the raw materials using a pyrolysis method, the method for preparing biofuel may be implemented in a way of preparing bio-oil with high heating value through a simple process, as well as the method may be implemented in a way of being economical and having effects on both carbon reduction and resource recycling. Through this, biofuel may be realized to be used in various application fields, like biodiesel. According to another aspect of the present disclosure, compared to a mechanical extraction method for oil, preparation costs are significantly reduced, there is no need of separate facilities for producing bio heavy oil, and as the yield of bio heavy oil increases, economic feasibility may be further improved.

(S1) Preparing Raw Materials Containing One or More Selected from Group Consisting of Cashew Nut Shell, Cashew Nut Shell Cake, Vegetable Oil Residue, and Husk;

The method for preparing biofuel according to the present disclosure includes preparing raw materials containing one or more selected from the group consisting of a cashew nut shell (CNS), a cashew nut shell cake (CNSC), a vegetable oil residue, and a husk. Specifically, the raw materials are biomass subject to thermal decomposition, and may be an easily available and environmentally friendly material.

In some examples, the vegetable oil residue may be a residue generated in a factory that produces the vegetable oil. Specifically, the vegetable oil of the vegetable oil residue may include one or more selected from the group consisting of palm oil, soybean oil, coconut oil, rapeseed oil, olive oil, corn oil, and peanut oil. More specifically, the vegetable oil of the vegetable oil residue may include palm oil.

In some examples, the husk may refer to a shell or by-product of the husk raw materials. Specifically, the husk may include one or more selected from the group consisting of a coffee husk, a palm oil husk (Palm kernel shell, PKS), and a grain husk. More specifically, the husk may include a coffee husk. Herein, the coffee husk may refer to a shell that surrounds a green coffee bean; or a shell that develops before harvesting the green coffee bean and extracting the coffee bean. In some examples, the palm oil husk may be a shell that surrounds an edible seed of an oil palm fruit. In some examples, the grain used as raw materials for the grain husk may include rice, barley, barley, wheat, oats, rye corn, millet, millet, wheat, sorghum, and buckwheat.

In some examples, when two or more types of raw materials are included, based on the total weight of the raw materials, the cashew nut shell, the cashew nut shell cake, the vegetable oil residue, and the husk may each independently be contained in an amount of 15% by weight or more, 20% by weight or more, 25% by weight or more, 30% by weight or more, 35% by weight or more, specifically 20% to 40% by weight.

In some examples, based on the total weight of the raw materials, the vegetable oil residue may be contained in an amount of 15% to 25% by weight, 16% to 24% by weight, 17% to 23% by weight, 18% to 22% by weight, 19% to 21% by weight, or 20% to 21% by weight.

In some examples, based on the total weight of the raw materials, the husk may be contained in an amount of 15% to 25% by weight, 16% to 24% by weight, 17% to 23% by weight, 18% to 22% by weight, 19% to 21% by weight, or 20% to 21% by weight.

### (S2) Obtaining Sub-Gas, Biochar, and Bio-Oil by Pyrolyzing Raw Materials Using Pyrolysis Method

The method for preparing biofuel according to the present disclosure includes (S2) obtaining sub-gas, biochar, and bio-oil by pyrolyzing the raw materials using a pyrolysis method. As a result, the method does not induce generation of toxic gas, hazardous waste, and wastewater.

Specifically, the thermal decomposition method is not particularly limited and may be a method of applying heat to the raw materials using various heat treatment means. In some examples, the pyrolysis method may include one or more methods selected from the group consisting of rotary kiln pyrolysis, fluidized bed pyrolysis, batch pyrolysis, and screw pyrolysis. The pyrolysis method may specifically include a rotary kiln pyrolysis method. According to some embodiments of the present disclosure, when using the rotary kiln pyrolysis method as the pyrolysis method, compared to other pyrolysis methods, rotation of a kiln body causes mixing and mixing movements, which allows the raw materials to flow through. This not only shortens the pyrolysis time, but also supplies heat necessary for pyrolysis to the solid raw materials as quickly as possible. Thereby, a yield of biofuel may be further increased.

In some examples, the rotary kiln pyrolysis method may be performed through a general rotary kiln reactor commonly used in the relevant technical field. Specifically, the rotary kiln pyrolysis method may be performed at 300° C. to 600° C. under normal pressure for 1 to 60 minutes, preferably at 350° C. to 550° C. under normal pressure for 10 to 50 minutes, and most preferably at 450° C. to 490° C. under normal pressure for 20 to 30 minutes. At this time, when any of the pressure, temperature, and time conditions for thermal decomposition are not within the range, a production yield of biochar and bio-oil from the cashew nut shell may be significantly low, or a large amount of impurities and anacardic acids may be contained, causing low purity and problems such as dermatitis and rashes when they come in contact with the skin.

In some examples, the fluidized bed pyrolysis method may be performed through various fluidized bed reactors commonly used in the relevant technical field. Herein, the fluidized bed reactor is a reactor mainly used in rapid thermal decomposition conditions and may have the characteristic of having a short residence time. Specifically, the fluidized bed pyrolysis method may be performed at 480° C. to 500° C. under normal pressure for 1 to 5 minutes.

In some examples, the batch pyrolysis method may be performed through a general batch pyrolysis reactor commonly used in the relevant technical field. Specifically, the batch pyrolysis method may be performed at 480° C. to 500° C. under normal pressure for 90 to 120 minutes.

In some examples, the screw pyrolysis method may be performed through a general screw pyrolysis reactor commonly used in the relevant technical field. Specifically, the screw pyrolysis method may be performed at 480° C. to 500° C. under normal pressure for 60 to 80 minutes. At this time, the rotation speed of the screw is not particularly limited, but may be specifically adjusted to 15 to 20 rpm.

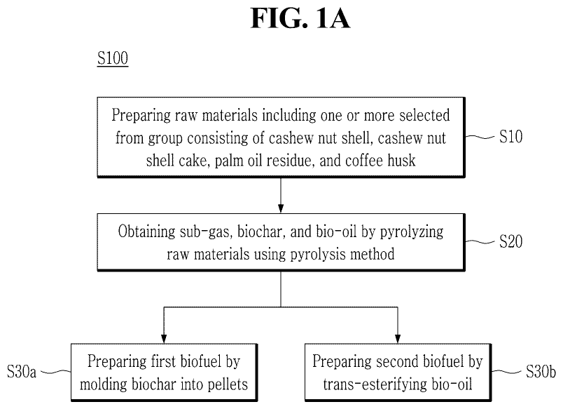

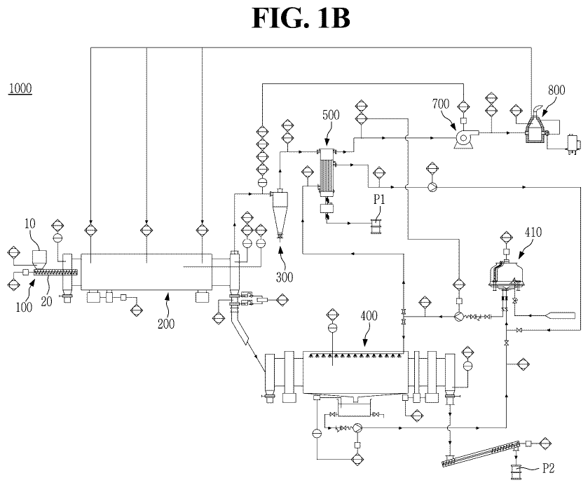

The sub-gas according to the present disclosure may be a gas generated in the process of thermal decomposition of the raw materials. At this time, when simply discharging the sub-gas, separate processing equipment for discharging the sub-gas may be required. In some embodiments of the present disclosure, the sub-gas may be reused as a heat source in the thermal decomposition method. Herein, the sub-gas may be reused as a heat source for pyrolyzing the raw materials by being supplied through a gas flow path to the reactor running to implement the pyrolysis method. According to some embodiments of the present disclosure, by reusing the sub-gas as a heat source for the pyrolysis method, the sub-gas is used as a heat source without separate processing equipment. Accordingly, the preparation costs and efficiency of the heat treatment process are further improved, which may, in turn, lead to a further increase in the yield of bio-oil. The principle of reusing the sub-gas as a heat source for the pyrolysis method is explained in detail in the description of FIG. 1b.

In some examples, the sub-gas may include one or more selected from the group consisting of light hydrocarbon gas having a carbon number of less than 4, light aliphatic hydrocarbon gas having a carbon number of 4 to 5, and light naphtha hydrocarbon gas having a carbon number of 5 to 6. Herein, based on the total volume of the sub-gas, the light hydrocarbon gas having a carbon number of less than 4 may be contained in an amount of 75% to 80% (v/v), and the light aliphatic hydrocarbon gas with a carbon number of 4 to 5 may be contained in an amount of 10% to 15% (v/v), and the light naphtha hydrocarbon gas having a carbon number of 5 to 6 may be contained in an amount of 10% to 15% (v/v).

In some embodiments of the present disclosure, the bio-oil may include phenol derivatives, and specifically, the phenol derivatives may include one or more selected from the group consisting of compounds represented by Formulas 1 to 3 below.

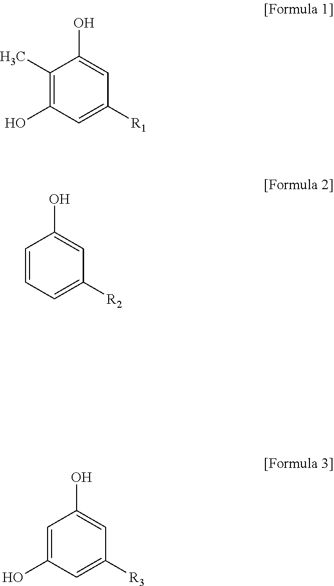

In Formulas 1 to 3, R₁ to R₃ are each independently a carbon chain functional group having a carbon number of 15 and containing one or more selected from the group consisting of an unsaturated bond and a saturated bond.

In some embodiments of the present disclosure, the bio-oil can be directly used as biofuel. If necessary, concentrating the bio-oil to prepare biofuel may be further provided. As a means to concentrate the bio-oil, a commercially available vacuum concentrator may be used.

In some embodiments of the present disclosure, provided may be a method for preparing biofuel, the method including one or more selected from the group consisting of (S3a) preparing a first biofuel by molding the biochar into pellets; and (S3b) preparing a second biofuel by trans-esterifying the bio-oil. Specifically, the steps (S3a) and (S3b) may each independently be performed. In some examples, the steps (S3a) and (S3b) may be performed simultaneously, in the order of the steps (S3a) and (S3b), or in the order of the steps (S3b) and (S3a).

Specifically, in the step (S3a), a ring die, a vertical ring die, a flat die, or a gear-type molding device may be used as a device for molding the biochar into pellets. At this time, the process conditions for forming pellets may be adjusted to have a moisture content factor of 12% to 15% and a particle size of 450 to 600 μm.

Specifically, a batch heat treatment mixing device may be used as a device to induce the trans-esterification reaction of the bio-oil in the step (S3b). At this time, the process conditions to induce the trans-esterification reaction of the bio-oil may be adjusted to have heat treatment conditions of 70° C. to 80° C. using an acid catalyst and alcohol. For example, content of the acid catalyst may be 1% by weight based on the total weight of a reaction solution, and a volume ratio of the acid catalyst (e.g., sulfuric acid) and alcohol may be 1:3. Herein, the reaction solution may be a mixture containing the bio-oil, acid catalyst, and alcohol.

Hereinafter, the configuration of the present disclosure will be described in more detail with reference to FIG. 1a.

FIG. 1a shows a flow chart showing a method for producing biofuel according to one embodiment of the present disclosure.

Referring to FIG. 1a, a method for preparing biofuel according to another embodiment of the present disclosure may include (S10) preparing raw materials containing one or more selected from the group consisting of a cashew nut shell, a cashew nut shell cake, a palm oil residue, and a coffee husk; and (S20) obtaining sub-gas, biochar, and bio-oil by pyrolyzing the raw materials using a pyrolysis method. At this time, (S30a) preparing a first biofuel by molding the biochar into pellets; and (S30b) preparing a second biofuel by trans-esterifying the bio-oil may each independently be performed.

### 2. Biofuel Production Apparatus

According to a further aspect of the present disclosure, provided is a biofuel production apparatus, the apparatus including a raw material injection unit where raw materials are injected; a pyrolysis reactor connected to the raw material injection unit; a cooler connected to the pyrolysis reactor; a heat exchanger connected to the pyrolysis reactor; a first recovery unit connected to the cooler and recovering biochar; and a second recovery unit connected to the heat exchanger and recovering bio-oil. Herein, the raw materials include one or more selected from the group consisting of a cashew nut shell, a cashew nut shell cake, a vegetable oil residue, and a husk.

Hereinafter, the configuration of the present disclosure will be described in more detail with reference to FIG. 1b. The above-mentioned parts and repeated explanations will be briefly explained or omitted.

FIG. 1b shows a biofuel production apparatus according to another embodiment of the present disclosure.

Referring to FIG. 1b, the biofuel production apparatus 1000 according to the present disclosure includes a raw material injection unit 100, a pyrolysis reactor 200, a cooler 400, a heat exchanger 500, a first recovery unit P1, and a second recovery unit P2.

### Raw Material Injection Unit (100)

The raw material injection unit 100 according to the present disclosure may be a device that receives raw materials and homogeneously mixes the received raw materials.

In some examples, the raw material injection unit 100 may include a sub-injection unit 10 and a kneading unit 20 connected to the sub-injection unit 10. For example, the raw materials may be injected into the raw material injection unit 100 through a hole provided in the sub-injection unit 10 and then homogeneously mixed through the kneading unit 20. For example, the kneading unit 20 may be a single screw device or a twin screw device.

The raw materials according to the present disclosure include one or more selected from the group consisting of a cashew nut shell, a cashew nut shell cake, a vegetable oil residue, and a husk.

### Pyrolysis Reactor (200)

The pyrolysis reactor 200 according to the present disclosure may produce sub-gas, preliminary biochar, and preliminary bio-oil by pyrolyzing the raw materials injected through the raw material injection unit 100. Herein, the preliminary biochar may refer to solids that are in a previous state of biochar. The preliminary bio-oil may refer to a previous state of the bio-oil, specifically, a state of the bio-oil before passing through the heat exchanger.

The pyrolysis reactor 200 according to the present disclosure is connected to the raw material injection unit 100, and specifically, the pyrolysis reactor 200 may be directly connected to the raw material injection unit 100.

In some embodiments of the present disclosure, the pyrolysis reactor 200 may include one or more selected from the group consisting of a rotary kiln reactor, a fluidized bed reactor, a batch pyrolysis reactor, and a screw pyrolysis reactor. The pyrolysis reactor 200 may specifically include a rotary kiln reactor. According to some embodiments of the present disclosure, when using the rotary kiln reactor, compared to other pyrolysis reactors, rotation of a kiln body causes mixing and mixing movements, which allows the raw materials to flow through. This not only shortens the pyrolysis time, but also supplies heat necessary for pyrolysis to the solid raw materials as quickly as possible. Thereby, a yield of biofuel may be further increased.

### Cooler (400)

The cooler 400 according to the present disclosure may freeze or cool the preliminary biochar obtained in the pyrolysis process.

In some examples, the cooler 400 is not particularly limited and may include various means for cooling the preliminary biochar. Specifically, an indirect rotary kiln type may be used to freeze the preliminary biochar. Specifically, the preliminary biochar may be frozen by applying air or cooling water onto the outer wall of the kiln. Herein, the cooling water may be supplied through a cooling tower 410, which will be described later.

### Heat Exchanger (500)

The heat exchanger 500 according to the present disclosure is a device that efficiently transfers heat based on different temperature differences using a fluid. The heat exchanger 500 may be a device that transfers heat of the preliminary bio-oil obtained through the pyrolysis process. Specifically, the temperature of the preliminary bio-oil may be indirectly lowered with the use of the cooling water supplied through the cooling tower 410, which will be described later. As the temperature of the preliminary bio-oil is lowered by the cooling method, bio-oil may be recovered in a liquid state through the first recovery unit P1, which will be described later.

The heat exchanger 500 according to the present disclosure may produce bio-oil by transferring the heat of the preliminary bio-oil. Specifically, the heat exchanger 500 may be connected to the thermal decomposition reactor 200, and more specifically, may be connected indirectly. At this time, a dust collector 300 may be interposed between the heat exchanger 500 and the thermal decomposition reactor 200. Herein, the dust collector 300 may rotate the sub-gas by centrifugal force to separate solid or liquid dust generated during the thermal decomposition process from the sub-gas. For example, the dust collector 300 may be a dry cyclone.

For example, the sub-gas is generated during the thermal decomposition process in the thermal decomposition reactor 200 and does not move to the cooler 400, but may be completely transferred to the dust collector 300, which will be described later.

### First Recovery Unit (P1) and Second Recovery Unit (P2)

The first recovery unit P1 according to the present disclosure is connected to the heat exchanger 500 and may recover the bio-oil.

The second recovery unit P2 according to the present disclosure is connected to the cooler 400 and may recover the biochar.

Specifically, the first and second recovery units P1 and P2 may be indirectly connected to each other.

### Other Components

The biofuel production apparatus 1000 according to the present disclosure may further include an air blower 700 connected to the heat exchanger 500. For example, the air blower 700 may serve to transfer the sub-gas discharged from the heat exchanger 500 to a combustion device 800, which will be described later.

The biofuel production apparatus 1000 according to the present disclosure may further include a cooling tower 410 connected to the heat exchanger 500 and the cooler 400. For example, the cooling tower 410 serves to lower the temperature of a coolant whose temperature has increased for heat exchange and to supply the cooled water to the heat exchanger 500 and/or the cooler 400. Thereby, in relation to the heat exchanger 500, the cooling tower 410 may lower the temperature of the sub-gas generated during the pyrolysis process and contribute to the recovery of bio-oil. In addition, in relation to the cooler 400, the cooling tower 410 may serve to prevent fire during biochar recovery by lowering the temperature of the preliminary biochar.

The biofuel production apparatus 1000 according to the present disclosure may further include the combustion device 800 connected to the air blower 700. Specifically, the combustion device 800 may be connected to the thermal decomposition reactor 200 and the heat exchanger 500. More specifically, the combustion device 800 may be directly connected to the thermal decomposition reactor 200 and indirectly connected to the heat exchanger 500. For example, the combustion device 800 may recover the sub-gas (uncondensed gas) discharged from the heat exchanger 500, combust the sub-gas, and supply the sub-gas to the pyrolysis reactor 200 as a heat source. Through the combustion device 800, CO₂, CO, and NOx (where x is 1 or 2) may be generated.

Although not specifically shown in FIG. 1b, a gas transfer device (not shown) may be additionally provided between the combustion device 800 and the pyrolysis reactor 200 to transfer the sub-gas burned in the combustion device 800 to the pyrolysis reactor 200.

In some examples, the temperature of the sub-gas burned through the combustion device 800 is not particularly limited and may be a temperature at which the raw materials may be pyrolyzed in the pyrolysis reactor 200. The temperature of the sub-gas may specifically be 300° C. to 600° C., 400° C. to 500° C., or 450° C. to 490° C.

### 3. Bio-Oil

According to a yet further aspect of the present disclosure, provided is bio-oil, which is derived from cashew nut shell liquid (CNSL) containing anacardic acids, in which the bio-oil contains phenol derivatives derived from the anacardic acids. In some examples, the anacardic acids may be thermally decomposed and converted to one or more phenol derivatives. Specifically, the phenol derivatives may be defined as a compound containing a phenol structure as a ballast.

According to a further embodiment of the present disclosure, the raw materials of the bio-oil are raw materials subject to thermal decomposition and may be any one selected from the group consisting of a cashew nut shell (CNS), a cashew nut shell cake (CNSC), and a combination thereof.

The anacardic acids according to the present disclosure is phenolic lipids and may be benzoic acid derivatives with a carboxyl group bonded to a benzene ring. Specifically, the anacardic acids may be converted into phenol derivatives, which will be described later, under predetermined heat conditions. At this time, the carboxyl group bonded to the benzene ring may be removed by decarboxylation under the thermal conditions.

In some embodiments of the present disclosure, based on the total weight of the cashew nut shell liquid, the anacardic acids may be contained in an amount of 60% to 70% by weight, 61% to 69% by weight, 62% to 68% by weight, 63% to 67% by weight, 64% to 67% by weight, 65% to 67% by weight, or 66% to 67% by weight. According to some embodiments of the present disclosure, when the content of anacardic acids is less than the numerical range, the content of phenol derivatives contained in bio-oil decreases, which will lead the production yield of bio-oil to be lowered. When the content of anacardic acids is above the numerical range, the content of anacardic acids remaining in the bio-oil increases, which will lead the yield of the bio-oil to be lowered or the content of impurities to be increased.

The phenol derivatives according to the present disclosure may be obtained by converting the anacardic acids through a chemical reaction. In some examples, the anacardic acids may be converted to the phenol derivatives through a decarboxylation reaction under thermal conditions.

In some embodiments of the present disclosure, the phenol derivatives may include one or more selected from the group consisting of compounds represented by Formulas 1 to 3 below.

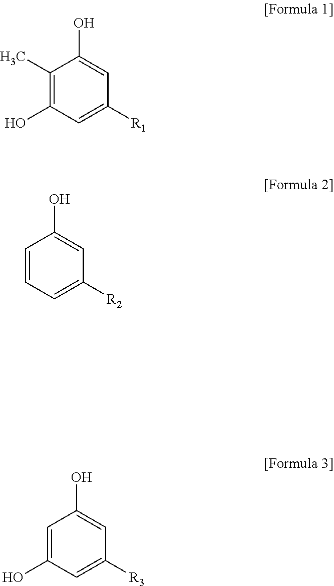

In Formulas 1 to 3, R₁ to R₃ may each independently be a carbon chain functional group having a carbon number of 15 and containing one or more selected from the group consisting of an unsaturated bond and a saturated bond. Herein, the unsaturated bond may include one or more selected from the group consisting of a carbon-carbon double bond and a carbon-carbon triple bond, and may specifically include a carbon-carbon double bond. In some examples, the carbon chain functional group may be a straight-chain or branched alkyl group having a carbon number of 15; or the carbon chain functional group may be a substituent in which one or more carbon-carbon single bonds bonded to the alkyl group are replaced with a double bond.

In some examples, R₁ to R₃ are each the same substituent, and may be any one or more selected from the group consisting of Formulas 4a to 4d below, and may specifically be Formula 4a. Herein, “*” may mean a point connecting to another part of a molecule.

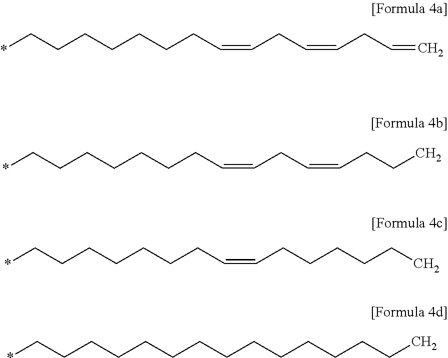 [SMILES: *CCCCCCC/C=C\C/C=C\CC=C ; *CCCCCCC/C=C\C/C=C\CCC ; *CCCCCCC/C=C\CCCCCC ; *CCCCCCCCCCCCCCC]

In some embodiments of the present disclosure, the bio-oil may contain 70% to 80% by weight of the compound represented by Formula 1 and 10% to 20% by weight of the compound represented by Formula 2, based on the total weight of compounds for the bio-oil. In some examples, based on the total weight of the bio-oil, the compound represented by Formula 1 may be contained in an amount of 71% to 79% by weight, 72% to 78% by weight, 73% to 77% by weight, 74% to 76% by weight, or 75% to 76% by weight. In some examples, based on the total weight of the bio-oil, the compound represented by Formula 2 may be contained in an amount of 11% to 19% by weight, 12% to 18% by weight, 13% to 17% by weight, 14% to 16% by weight, or 15% to 16% by weight. According to some embodiments of the present disclosure, when the content of the compounds represented by Formulas 1 and 2 are not within the numerical range, it may not meet the bio heavy oil standard.

In some embodiments of the present disclosure, the bio-oil may further include more than 0% and 10% or less by weight of the compound represented by Formula 3. In some examples, based on the total weight of the bio-oil, the compound represented by Formula 3 may be contained in an amount of 1% to 10% by weight, 2% to 9% by weight, 3% to 8% by weight, 4% to 7% by weight, or 5% to 6% by weight. According to some embodiments of the present disclosure, when the content of the compound represented by Formula 3 is not within the numerical range or is above the numerical range, it may not meet the bio heavy oil standard.

For example, the content of the compounds represented by Formulas 1 to 3 described above may be analyzed through a gas chromatography mass spectrometry (GC-MS) analysis method commonly used in the relevant technical field.

In some embodiments of the present disclosure, based on the total weight of the bio-oil, the phenol derivatives may be contained in an amount of 70% to 100% by weight, 71% to 79% by weight, 72% to 78% by weight, 73% to 77% by weight, 74% to 76% by weight, or 75% to 76% by weight. According to some embodiments of the present disclosure, when the content of the phenol derivatives is within the numerical range, the yield and purity of bio-oil may be further increased, and excellent biofuel characteristics may be expressed. For example, the content of the phenol derivatives described above may be analyzed using the GC-MS analysis method commonly used in the relevant technical field.

In some embodiments of the present disclosure, the cashew nut shell liquid may show exothermic properties at 150° C. to 500° C., specifically at 200° C. to 350° C., and more specifically at 200° C. to 300° C. In some examples, specific heat (Cp) of the cashew nut shell liquid may be 20 W/g·° C. or higher at 200° C. or higher. Specifically, the specific heat (Cp) of the cashew nut shell liquid may be 20 to 50 W/g·° C., 25 to 45 W/g·° C., or 30 to 45 W/g·° C. at 250° C. to 300° C. For example, the exothermic properties of the cashew nut shell liquid may be analyzed using a differential scanning calorimetry (DSC) analysis method under the analysis conditions of a nitrogen flow rate of 50 ml/min, a temperature increase of 20° C./min, and a temperature increase of 25° C. to 500° C.

According to a still yet further aspect of the present disclosure, provided may be biofuel prepared from the bio-oil according to some embodiments. In some examples, the biofuel is not particularly limited and may be biodiesel, and may specifically be a transportation fuel. In some other examples, the biofuel may be any one selected from the group consisting of a land improvement agent, a heat source for pyrolysis, and a wood pellet boiler fuel.

In some examples, the bio-oil may react with an acid compound containing a carboxyl group to undergo an esterification reaction. After the esterification reaction, bio heavy oil may be obtained through an ash removal reaction at about 80° C. or higher and an impurity removal reaction.

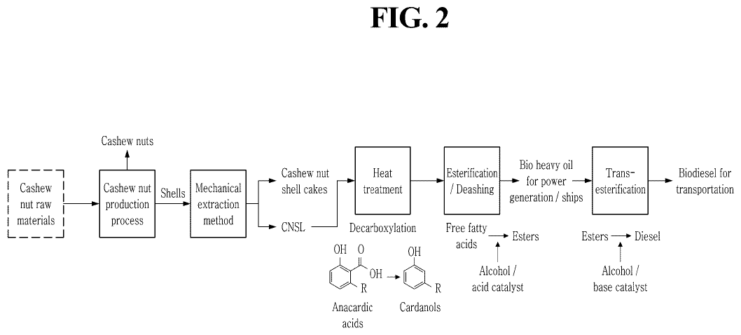

FIG. 2 shows a flow chart showing a method for producing biofuel according to a further embodiment of the present disclosure.

Referring to FIG. 2, the method for preparing biofuel according to an embodiment of the present disclosure may include separating a cashew nut and cashew nut shell from a cashew obtained from a cashew tree; and pyrolyzing the cashew nut shell to obtain biochar and bio-oil.

In some examples, through the pyrolysis, most of the cashew nut shell liquid contained in the cashew nut shell may be recovered, significantly improving productivity compared to the conventional mechanical extraction process. This pyrolysis may be performed at 300° C. to 600° C. under normal pressure for 1 to 60 minutes, preferably at 350° C. to 550° C. under normal pressure for 10 to 50 minutes, and most preferably at 450° C. to 490° C. under normal pressure for 20 to 30 minutes. At this time, when any of the pressure, temperature, and time conditions for thermal decomposition is not within the ranges, a production yield of biochar and bio-oil from the cashew nut shell was significantly low, or a large amount of impurities and anacardic acids were contained, causing low purity and problems such as dermatitis and rashes when they came in contact with the skin.

In some examples, the biochar may have a heating value of 5,000 to 8,000 kcal/kg, moisture of 1% to 8% by weight, and ash content of 1% to 7% by weight. The biochar preferably has a heating value of 5,700 to 7,300 kcal/kg, moisture of 2% to 7% by weight, and ash content of 4% to 6.8% by weight. The biochar most preferably has a heating value of 6,400 to 7,290 kcal/kg, moisture of 2% to 5% by weight, and ash content of 5.5% to 6.5% by weight.

The biochar has a low moisture content and high heating value, so the biochar may be used as a heat source in the pyrolysis process. The biochar has the advantage of being applicable as a land improvement agent that may improve the growth of plants while offering the carbon sequestration effect.

In some examples, the bio-oil may be bio heavy oil containing 1 to 20 ppm of potassium (K), preferably 2 to 17 ppm of potassium (K), and 1 to 5 ppm of sodium (Na), preferably 1 to 4 ppm of sodium (Na), based on the total content of the bio-oil. The bio-oil has very low calcium and sodium content, which are ash-causing components, so high-purity bio-oil may be obtained. The bio-oil may be used directly as bio heavy oil without a separate refining process. The bio heavy oil may be used as fuel for power generation or ships.

In some examples, the bio-oil may have a heating value of 8,000 to 9,800 kcal/kg, a total acid value of 5 to 20 mgKOH/g, and an oil production yield of 30% or more. Preferably, the bio-oil has a heating value of 8,200 to 9,100 kcal/kg, a total acid value of 7 to 13 mgKOH/g, and an oil production yield of 35% or more. Most preferably, the bio-oil may have a heating value of 9,000 to 9,700 kcal/kg, a total acid value of 10 to 12 mgKOH/g, and an oil production yield of 40% or more.

Hereinafter, embodiments of the present disclosure will be described in detail so that those skilled in the art can easily implement the present disclosure. However, this is only an example, and the scope of the present disclosure is not limited by the following.

### Preparation Example 1: Preparation of Biofuel

### Comparative Example 1: Method for Obtaining Cashew Nut Shell Cake and Cashew Nut Shell Liquid by Mechanical Extraction Method

Cashew nuts and cashew nut shells were separated from cashews obtained from cashew trees by mechanical removal. Herein, cashew nut shell liquid was contained in an amount of 20% by weight in the cashew nut shells. Anacardic acids were contained in an amount of 67% by weight in the cashew nut shell liquid.

10 kg of the cashew nut shells was mechanically extracted using a press for 10 minutes under a pressure of 0.25 MPa and at room temperature. As a result, 8 kg of cashew nut shell cake and 2 kg of cashew nut shell liquid were obtained.

### Example 1: Method of Obtaining Biochar and Bio-Oil Using Pyrolysis Method

### Step to Separate Cashew Nuts and Cashew Nut Shells:

Cashew nuts and cashew nut shells were separated from cashews in the same manner as Comparative Example 1. Herein, cashew nut shell liquid was contained in an amount of 30% by weight in the cashew nut shells. Anacardic acids were contained in an amount of 67% by weight in the cashew nut shell liquid. The content of the anacardic acids contained in the cashew nut shell liquid was measured using a GC-MS analysis method.

### Step to Pyrolyze Cashew Nut Shells:

1,000 kg of cashew nut shells were placed in a rotary-kiln type pyrolysis reactor and pyrolyzed at a temperature of 470° C. for 30 minutes under normal pressure and 5% oxygen concentration inside the reactor. As a result, 350 kg of biochar and 400 kg of bio-oil were obtained.

### Example 2: Case of Using Cashew Nut Shell Cake Instead of Cashew Nut Shells Unlike Example 1

Bio-oil was obtained in the same manner as in Example 1, but instead of the cashew nut shells, 1,000 kg of cashew nut shell cakes prepared by the method according to Comparative Example 1 was placed into a rotary-kiln type pyrolysis reactor. As a result, 300 kg of biochar and 350 kg of bio-oil were obtained.

### Experimental Example 1: Characteristic Analysis of Cashew Nut Shell Liquid

Exothermic temperature and specific heat of cashew nut shell liquid according to Example 1 were measured under an analysis method and analysis conditions shown in Table 1 below.

TABLE 1

| | Analysis | Analysis | Cashew nut shell |
|---|---|---|---|
| Division | method | condition | liquid of Example 1 |
| Exothermic | DSC | Nitrogen flow | Exothermic |
| temperature | | rate 50 ml/min, | temperature 200° C.- |
| | | temperature | 300° C. |
| | | increase | |
| | | 20° C./min, | |
| | | temperature | |
| | | increase 25° C.- | |
| | | 500° C. | |
| Specific heat | DSC | Nitrogen flow | Above 20 W/g° C. |
| (W/g° C.) | | rate 50 ml/min, | (above 200° C. |
| | | temperature | temperature |
| | | increase | condition) |
| | | 20° C./min, | |
| | | temperature | |
| | | increase 25° C.- | |
| | | 500° C. | |

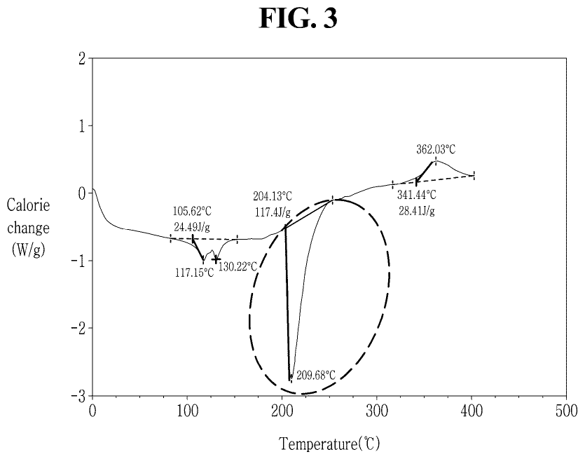

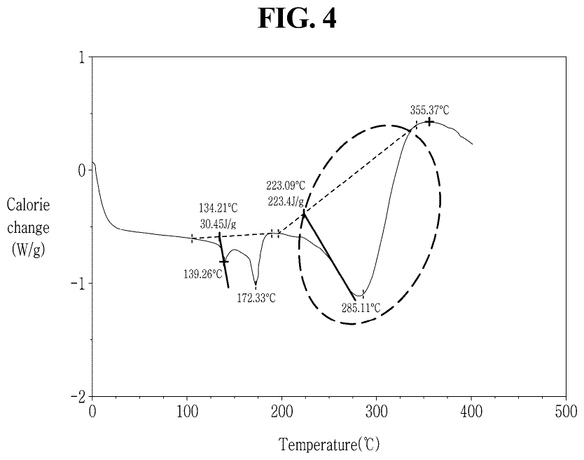

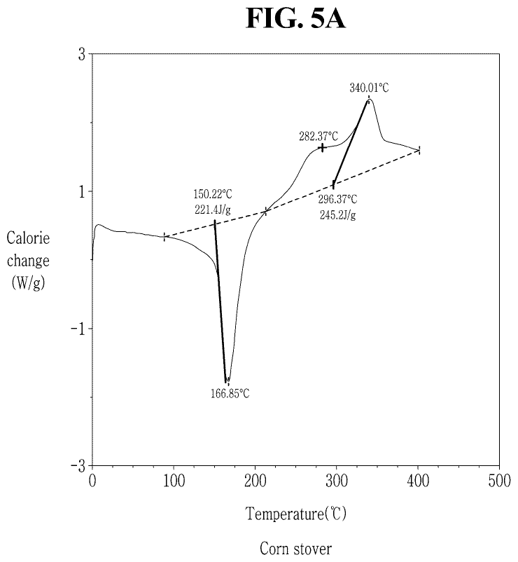

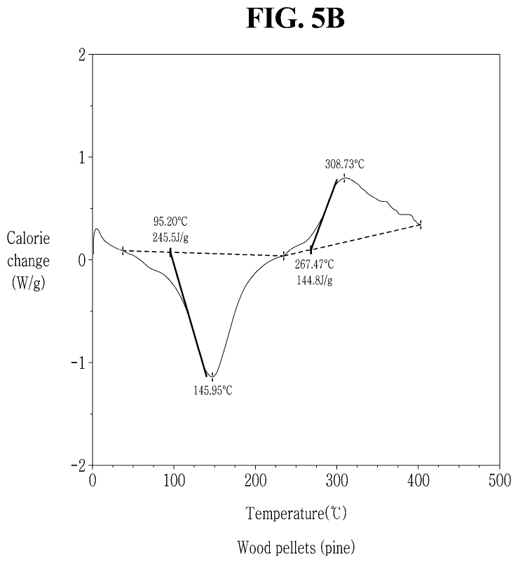

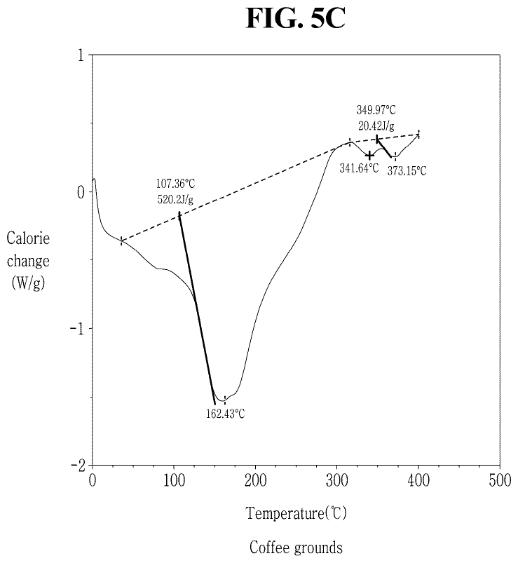

FIG. 3 shows a DSC graph of cashew nut shells in the method according to Example 1. FIG. 4 shows a DSC graph of cashew nut shell liquid in the method according to Example 1. FIG. 5a shows a DSC graph of oil made from corn stover. FIG. 5b shows a DSC graph of oil made from wood pellets. FIG. 5c shows a DSC graph of oil made from coffee grounds.

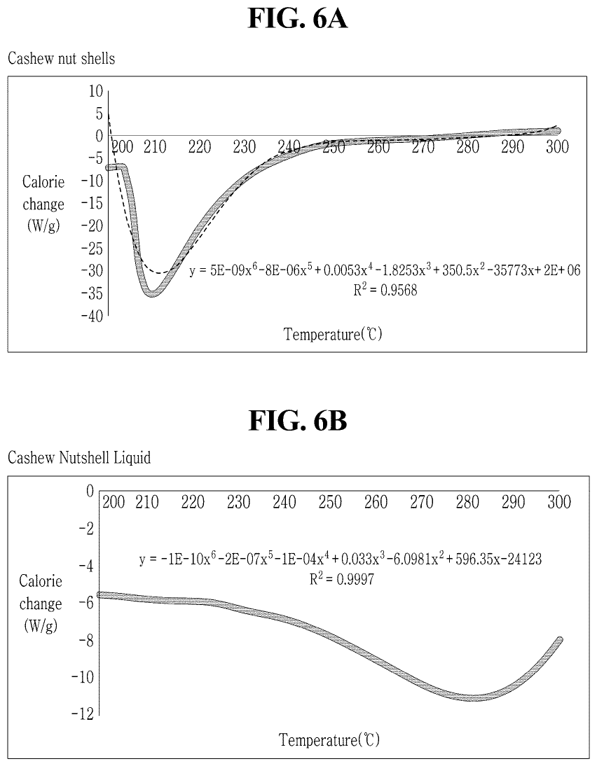

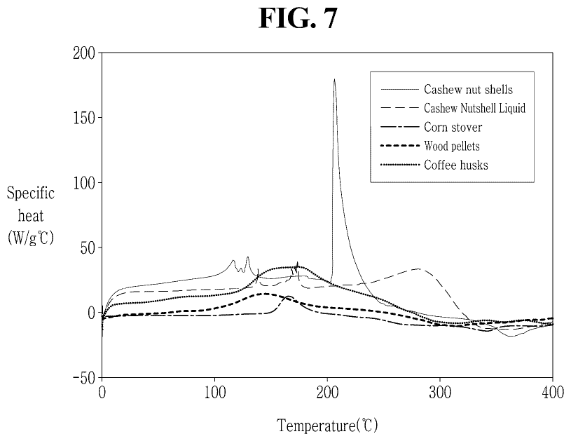

FIG. 6a shows a DSC graph of cashew nut shells according to Example 1 at 200° C. to 300° C., and a calculation formula to confirm exothermic properties of the cashew nut shells. FIG. 6a shows a DSC graph of cashew nut shell liquid according to Example 1 at 200° C. to 300° C., and a calculation formula to confirm exothermic properties of the cashew nut shell liquid. FIG. 7 shows graphs showing specific heats depending on each temperature for the cashew nut shell (CNS), cashew oil (CNSL), corn stover, wood pellet, and coffee husk.

Referring to FIGS. 3 to 7, in the method according to Example 1, it was confirmed that cashew nut shells and cashew nut shell liquid, unlike other raw materials, underwent an exothermic reaction at about 200° C. to 300° C. Specifically, the exothermic properties in FIGS. 6a and 6b could be calculated through Equations 1 and 2 below.

$$[ Equation 1 ]$$

$$y = 5 E - 09 {x}^{6} - 8 E - 06 {x}^{5} + 0.0053 {x}^{4} - 1.8253 {x}^{3} + 350.5 {x}^{2} - 357 \; 73 x + 2 E + 06$$

$$[ Equation 2 ]$$

$$y = - 1 E - 10 {x}^{6} + 2 E - 07 {x}^{5} - 1 E - 04 {x}^{4} + 0.033 {x}^{3} - 6.0981 {x}^{2} + 596.35 x - 24123$$

In Equations 1 and 2, x is temperature (° C.) and y is heat flow (W/g).

### Experimental Example 2: Analysis of Biochar and Bio-Oil

Regarding the biochar and bio-oil obtained in Examples 1 and 2 and Comparative Example 1, heating value of biochar, moisture and ash content of the biochar, and lower heating value (LHV), K content, Na content, total acid value, and oil production yield of bio-oil were measured. The results are shown in Tables 2 and 3 below.

TABLE 2

| | | | | | Required |
|---|---|---|---|---|---|
| | | | | | physical |
| | | | | | properties |
| | Analysis | Comparative | | | of bio heavy |
| Division | method | Example 1 | Example 1 | Example 2 | oil |
| Lower | Calorimeter | 7,000 | 7,290 | 7,020 | — |
| heating | (Ministry of | | | | |
| value (LHV) | Environment | | | | |
| of biochar | Notice No. | | | | |
| (kcal/kg) | 2020-219) | | | | |
| K content of | ICP-OES | 9,000 | 3 | 17 | 50 or less |
| bio-oil (ppm) | | | | | |
| Na content of | ICP-OES | 1,000 | 3 | 4 | 50 or less |
| bio-oil (ppm) | | | | | |
| Total acid | Total acid | 32 | 11 | 10.97 | 25 or less |
| value of bio- | value | | | | |
| oil (mg | measurement | | | | |
| KOH/g) | (Color | | | | |
| | indicator | | | | |
| | titration | | | | |
| | method, KS M | | | | |
| | ISO 6618: 1997) | | | | |
| Oil | (Output/ | 6 | 40 | 35 | — |
| production | Input)X100 | | | | |
| yield (%) | | | | | |

TABLE 3

| | Analysis | Comparative | | |
|---|---|---|---|---|
| Division | method | Example 1 | Example 1 | Example 2 |
| Moisture (% by | Moisture | 10 or more | 2 | 4.4 |
| weight) | measurement | | | |
| | (Ministry of | | | |
| | Environment | | | |
| | Notice No. | | | |
| | 2020-219) | | | |
| Ash content (% | Ash content | 1.9 | 6.2 | 6.2 |
| by weight) | measurement | | | |
| | (Ministry of | | | |
| | Environment | | | |
| | Notice No. | | | |
| | 2020-219) | | | |

Additionally, regarding the biochar and bio-oil obtained in Example 1, components in the biochar (Table 4) and bio-oil (Table 5) were analyzed using the fuel characteristics analysis method (KS M 0010:2016, KS M ISO 6245:2001, KS M 2057:2006, KS M ISO 10370:2014, Ministry of Environment Notification No. 2020-219, ASTM D7582-15, ICP-OES). Thereafter, the results are shown in Tables 4 and 5 below.

TABLE 4

| Biochar industry analysis | | | | | | | | | | Heating | |
|---|---|---|---|---|---|---|---|---|---|---|---|
| wt % | | | | Biochar elemental | | | | | Chlorine | value | |
| | Ash | Volatile | Fixed | analysis wt % (ash free) | | | | | wt % | kcal/kg | |
| Moisture | content | matter | carbon | C | H | N | O | S | Cl | Higher | Lower |
| 2.00 | 6.20 | 12.60 | 79.20 | 86.25 | 3.23 | 1.30 | 9.21 | 0.01 | 0.03 | 7290 | 7120 |

TABLE 5

| Bio-oil industrial | | | | | | | | | Heating | | | |
|---|---|---|---|---|---|---|---|---|---|---|---|---|
| analysis wt % | | | | Bio-oil elemental analysis | | | | | value | | Alkali | |
| | Ash | Volatile | Residual | wt % (ash free) | | | | | kcal/kg | | metal ppm | |
| Moisture | content | matter | carbon | C | H | N | O | S | Higher | Lower | Na | K |
| 0.10 | 0.20 | 98.88 | 0.82 | 83.02 | 10.48 | 0.31 | 6.18 | 0.01 | 9610 | 9030 | 3.00 | 3.00 |

### Experimental Example 3: Content of Anacardic Acids in Cashew Nut Shell Liquid and Phenol Derivatives in Bio-Oil

In the method according to Example 1 or 2, the content of anacardic acids contained in cashew nut shell liquid was measured using a GC-MS analysis method. The content of phenol derivatives derived from the anacardic acids was measured using the GC-MS analysis method. Specifically, the phenol derivatives may be made from cardanols, cardols, and 2-methyl-cardols. R₁ to R₃ bonded to the benzene ring in each of the cardanols, cardols, and 2-methyl-cardols were a functional group represented by Formula 4a below.

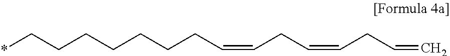 [SMILES: *CCCCCCC/C=C\C/C=C\CC=C]

TABLE 6

| Division | Example 1 | Example 2 |
|---|---|---|
| Raw materials | Cashew nut shell | Cashew nut shell cake |
| | (CNS) | (CNSC) |
| Anacardiic acid content | 0.0 | 0.0 |
| (% by weight) | | |
| Cardanols (% by weight) | 95.4 | 94.7 |
| Cardols (% by weight) | 4.6 | 5.3 |
| 2-Methyl cardols (% by | 0.0 | 0.0 |
| weight) | | |

Although the preferred examples of the present disclosure have been described in detail above, the scope of the present disclosure is not limited thereto. Various modifications and improvements made by those skilled in the art using the basic concept of the present disclosure defined in the following claims also fall within the scope of the present disclosure.

### EXPLANATION OF SYMBOLS

1000: Biofuel production apparatus 100: Raw material injection unit
200: Pyrolysis reactor 300: Dust collector
400: Cooler 500: Heat exchanger
410: Cooling tower 700: Air blower
800: Combustion device P1: First recovery unit
P2: Second recovery unit

What is claimed is:

1. A method for preparing biofuel, the method comprising:
(S1) preparing raw materials containing one or more selected from the group consisting of a cashew nut shell, a cashew nut shell cake, a vegetable oil residue, and a husk; and
(S2) obtaining sub-gas, biochar, and bio-oil by pyrolyzing the raw materials using a pyrolysis method.

2. The method of claim 1, wherein vegetable oil of the vegetable oil residue comprises one or more selected from the group consisting of palm oil, soybean oil, coconut oil, rapeseed oil, olive oil, corn oil, and peanut oil.

3. The method of claim 1, wherein the husk comprises one or more selected from the group consisting of a coffee husk, a palm oil husk (Palm kernel shell, PKS), and a grain husk.

4. The method of claim 1, wherein the pyrolysis method comprises one or more methods selected from the group consisting of rotary kiln pyrolysis, fluidized bed pyrolysis, batch pyrolysis, and screw pyrolysis.

5. The method of claim 1, wherein the sub-gas is reused as a heat source for the pyrolysis method.

6. The method of claim 1, wherein the bio-oil comprises phenol derivatives.

7. The method of claim 6, wherein the phenol derivatives comprise one or more selected from the group consisting of compounds represented by Formulas 1 to 3 below: 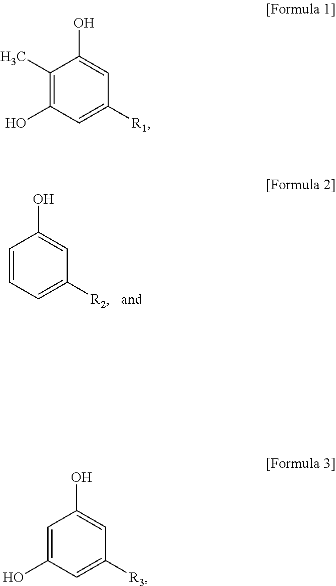
wherein, in Formulas 1 to 3, R₁ to R₃ are a carbon chain functional group having a carbon number of 15 and containing one or more selected from the group consisting of an unsaturated bond and a saturated bond.

8. The method of claim 1, the method further comprising one or more selected from the group consisting of:
(S3a) preparing a first biofuel by molding the biochar into pellets; and
(S3b) preparing a second biofuel by trans-esterifying the bio-oil.

9. A biofuel production apparatus, comprising:
a raw material injection unit in which raw materials are injected;
a pyrolysis reactor connected to the raw material injection unit;
a cooler connected to the pyrolysis reactor;
a heat exchanger connected to the pyrolysis reactor;
a first recovery unit connected to the cooler and recovering biochar; and
a second recovery unit connected to the heat exchanger and recovering bio-oil,
wherein the raw materials comprise one or more selected from the group consisting of a cashew nut shell, a cashew nut shell cake, a vegetable oil residue, and a husk.

10. The apparatus of claim 9, wherein the pyrolysis reactor comprises one or more selected from the group consisting of a rotary kiln reactor, a fluidized bed reactor, a batch pyrolysis reactor, and a screw pyrolysis reactor.

11. The apparatus of claim 9, further comprising:
a combustion device connected to the heat exchanger and the pyrolysis reactor.

12. Bio-oil, which is derived from cashew nut shell liquid (CNSL) containing anacardic acids,
wherein the bio-oil contains phenol derivatives derived from the anacardic acids.

13. The bio-oil of claim 12, wherein the anacardic acids are contained in an amount of 60% to 70% by weight based on the total weight of the cashew nut shell liquid.

14. The bio-oil of claim 12, wherein the phenol derivatives comprise one or more selected from the group consisting of compounds represented by Formulas 1 to 3 below: 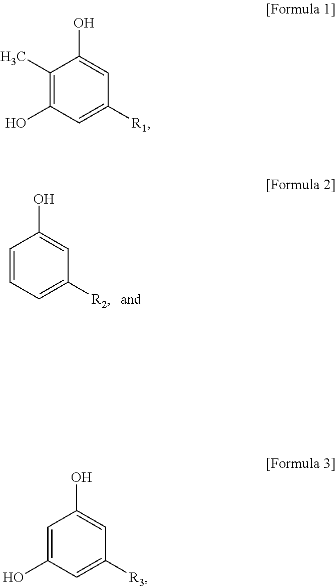
wherein, in Formulas 1 to 3, R₁ to R₃ are each independently a carbon chain functional group having a carbon number of 15 and containing one or more selected from the group consisting of an unsaturated bond and a saturated bond.

15. The bio-oil of claim 14, wherein the bio-oil contains 70% to 80% by weight of the compound represented by Formula 1 and 10% to 20% by weight of the compound represented by Formula 2.

16. The bio-oil of claim 15, wherein the bio-oil further contains more than 0% and less than or equal to 10% by weight of the compound represented by Formula 3.
